(19) United States
(12) Patent Application Publication
(10) Pub. No.: US 2025/0381805 A1
(43) Pub. Date: Dec. 18, 2025

(54) SYSTEM FOR AUTO-LOCATION OF TIRES

(71) Applicant: The Goodyear Tire & Rubber Company, Akron, OH (US)

(72) Inventors: Kanwar Bharat Singh, Copley, OH (US); Sparsh Sharma, Luxembourg City (LU)

(21) Appl. No.: 19/289,538

(22) Filed: Aug. 4, 2025

Related U.S. Application Data
(63) Continuation-in-part of application No. 17/151,310, filed on Jan. 18, 2021, now abandoned.

(51) Int. Cl. B60C 23/04; B60C 19/00; B60C 23/20

(52) U.S. Cl. CPC B60C 23/0416; B60C 19/00; B60C 23/0488; B60C 23/20; B60C 2019/004

(57) ABSTRACT

An auto-location system locates a position of a tire that supports a vehicle. The system includes a sensor unit that is mounted on the tire and includes a footprint length measurement sensor to measure a length of a footprint of the tire. A processor is in electronic communication with the sensor unit and receives the measured footprint length. A driving event classifier is executed on the processor and employs the measured footprint length to determine the position of the tire on the vehicle. An auto-location output block is executed on the processor and receives the determined position of the tire on the vehicle and generates a message correlating the sensor unit to the position of the tire on the vehicle.

### FIELD OF THE INVENTION

The invention relates generally to tire monitoring systems. More particularly, the invention relates to systems that include sensors mounted on vehicle tires to measure tire parameters. Specifically, the invention is directed to a system for locating the position of a tire on a vehicle employing footprint length as measured by a sensor mounted on the tire.

### BACKGROUND OF THE INVENTION

Sensors have been mounted on vehicle tires to monitor certain tire parameters, such as pressure and temperature. Systems that include sensors which monitor tire pressure are known in the art as tire pressure monitoring systems (TPMS). For example, a tire may have a TPMS sensor that transmits a pressure signal to a processor, which generates a low pressure warning when the pressure of the tire falls below a predetermined threshold. It is desirable that systems including pressure sensors be capable of identifying the specific tire that is experiencing low air pressure, rather than merely alerting the vehicle operator or a fleet manager that one of the vehicle tires is low in pressure.

The process of identifying which sensor sent a particular signal and, therefore, which tire may have low pressure, is referred to as auto-location or localization. Effective and efficient auto-location or localization is a challenge in TPMS, as tires may be replaced, rotated, and/or changed between summer and winter tires, altering the position of each tire on the vehicle. Additionally, power constraints typically make frequent communications and auto-location or localization of signal transmissions impractical.

Prior art techniques to achieve signal auto-location or localization have included various approaches. For example, low frequency (LF) transmitters have been installed in the vicinity of each wheel of the tire, two-axis acceleration sensors have been employed which recognize a rotation direction of the tire for left or right tire location determination, as well as methods distinguishing front tires from rear tires using radio frequency (RF) signal strength. The prior art techniques have deficiencies that make location of a sensor mounted in a tire on a vehicle either expensive or susceptible to inaccuracies.

As a result, there is a need in the art for a system that provides economical and accurate identification of the location of a position of a tire on a vehicle.

### SUMMARY OF THE INVENTION

According to an aspect of an exemplary embodiment of the invention, an auto-location system for locating a position of a tire supporting a vehicle is provided. The system includes a sensor unit that is mounted on the tire, and which includes a footprint length measurement sensor to measure a length of a footprint of the tire. A processor is in electronic communication with the sensor unit and receives the measured footprint length. A driving event classifier is executed on the processor and employs the measured footprint length to determine the position of the tire on the vehicle. An auto-location output block is executed on the processor and receives the determined position of the tire on the vehicle and generates a message correlating the sensor unit to the position of the tire on the vehicle.

### BRIEF DESCRIPTION OF THE DRAWINGS

The invention will be described by way of example and with reference to the accompanying drawings, in which:

FIG. 1 is a schematic perspective view of a vehicle that includes a tire employing an exemplary embodiment of the auto-location system of the present invention;

FIG. 2 is a plan view of a footprint of the tire shown in FIG. 1;

FIG. 3A is a schematic diagram of aspects of an exemplary embodiment of the auto-location system of the present invention;

FIG. 3B is a schematic diagram of an aspect of the system shown in FIG. 3A;

FIG. 3C is a schematic diagram of another aspect of the system shown in FIG. 3A;

FIG. 3D is a schematic diagram of another aspect of the system shown in FIG. 3A;

FIG. 3E is a schematic diagram of another aspect of the system shown in FIG. 3A;

FIG. 3F is a schematic diagram of another aspect of the system shown in FIG. 3A;

FIG. 3G is a schematic diagram of another aspect of the system shown in FIG. 3A; and

FIG. 3H is a schematic diagram of another aspect of the system shown in FIG. 3A.

Similar numerals refer to similar parts throughout the drawings.

### Definitions

“ANN” or “artificial neural network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Axial” and “axially” means lines or directions that are parallel to the axis of rotation of the tire.

“CAN bus” is an abbreviation for controller area network.

“Circumferential” means lines or directions extending along the perimeter of the surface of the annular tread perpendicular to the axial direction.

“Equatorial centerplane (CP)” means the plane perpendicular to the tire's axis of rotation and passing through the center of the tread.

“Footprint” means the contact patch or area of contact created by the tire tread with a flat surface as the tire rotates or rolls.

“Inboard side” means the side of the tire nearest the vehicle when the tire is

mounted on a wheel and the wheel is mounted on the vehicle.

“Lateral” means an axial direction.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Tread element” or “traction element” means a rib or a block element defined by a shape having adjacent grooves.

### DETAILED DESCRIPTION OF THE INVENTION

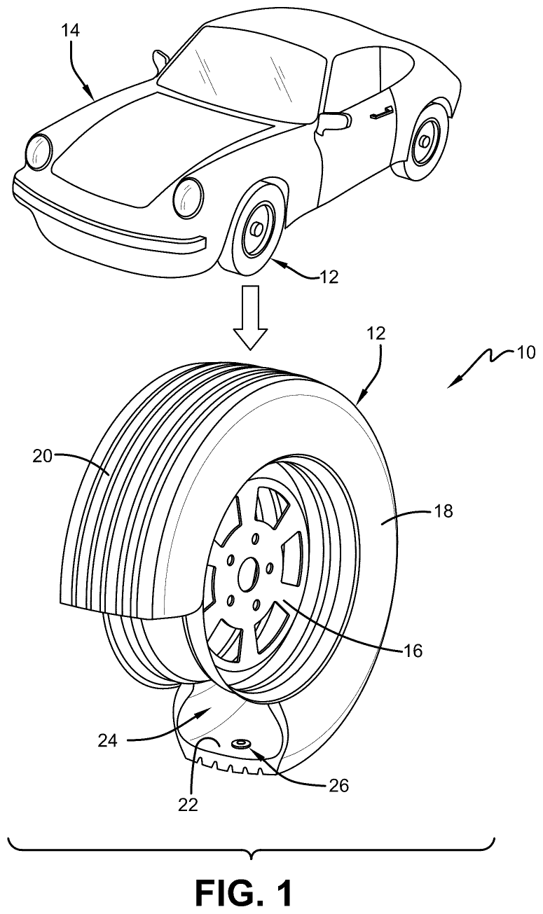

With reference to FIGS. 1 through 3H, an exemplary embodiment of an auto-location system of the present invention is indicated at 10. With particular reference to FIG. 1, the system 10 locates the position of each tire 12 supporting a vehicle 14. The position of each tire 12 shall be referred to herein by way of example as left front 12a, right front 12b, left rear 12c, and right rear 12d. While the vehicle 14 is depicted as a passenger car, the invention is not to be so restricted. The principles of the invention find application in other vehicle categories, such as commercial trucks, in which vehicles may be supported by more or fewer tires than those shown in FIG. 1.

The tires 12 are of conventional construction, and each tire is mounted on a respective wheel 16 as known to those skilled in the art. Each tire 12 includes a pair of sidewalls 18 (only one shown) that extend to a circumferential tread 20. An innerliner 22 is disposed on the inner surface of the tire 12, and when the tire is mounted on the wheel 16, an internal cavity 24 is formed, which is filled with a pressurized fluid, such as air.

A sensor unit 26 is attached to the innerliner 22 of each tire 12 by means such as an adhesive, and measures certain parameters or conditions of the tire as will be described in greater detail below. It is to be understood that the sensor unit 26 may be attached in such a manner, or to other components of the tire 12, such as on or in one of the sidewalls 18, on or in the tread 20, on the wheel 16, and/or a combination thereof. For the purpose of convenience, reference herein shall be made to mounting of the sensor unit 26 on the tire 12, with the understanding that such mounting includes all such types of attachment.

The sensor unit 26 is mounted on each tire 12 for the purpose of detecting certain real-time tire parameters, such as tire pressure 34 and tire temperature 36. For this reason, the sensor unit 26 preferably includes a pressure sensor and a temperature sensor, and may be of any known configuration. The sensor unit 26 may be referred to as a tire pressure monitoring system (TPMS) sensor. The sensor unit 26 preferably also includes electronic memory capacity for storing identification (ID) information for the sensor unit mounted in each tire 12, known as sensor ID information, which includes a unique identifying number or code for each sensor unit.

The electronic memory capacity in the sensor unit may also store ID information for each tire 12, known as tire ID information. Alternatively, tire ID information may be included in another sensor unit, or in a separate tire ID storage medium, such as a tire ID tag, which preferably is in electronic communication with the sensor unit 26. The tire ID information may be correlated to specific construction data for each tire 12, including: the tire type; tire model; size information, such as rim size, width, and outer diameter; manufacturing location; manufacturing date; a treadcap code that includes or correlates to a compound identification; and a mold code that includes or correlates to a tread structure identification.

As described above, the phrases sensor ID and sensor ID information refer to identification of the tire-mounted sensor unit 26. The system 10 employs sensor ID and sensor ID information to identify each sensor unit 26, and analyses data from each sensor unit to determine the location of each respective tire 12 on the vehicle 14, as will be described in detail below. In the art, the phrase tire ID is sometimes used in connection with identification of the location of each tire 12 on the vehicle 14. However, as described above, the phrases tire ID and tire ID information as used herein refer to specific construction data for each tire 12, rather than locating the position of each tire on the vehicle 14.

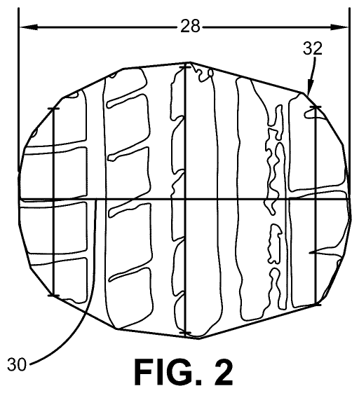

Turning to FIG. 2, the sensor unit 26 (FIG. 1) preferably also measures a length 28 of a centerline 30 of a footprint 32 of the tire 12. More particularly, as the tire 12 contacts the ground, the area of contact created by the tread 20 with the ground is known as the footprint 32. The centerline 30 of the footprint 32 corresponds to the equatorial centerplane of the tire 12, which is the plane that is perpendicular to the axis of rotation of the tire and which passes through the center of the tread 20. The sensor unit 26 thus measures the length 28 of the centerline 30 of the tire footprint 32, which is referred to herein as the footprint length 28. Any suitable technique for measuring the footprint length 28 may be employed by the sensor unit 26. For example, the sensor unit 26 may include a strain sensor or piezoelectric sensor that measures deformation of the tread 20 and thus indicates the footprint length 28.

The sensor unit 26 may also include an accelerometer for measuring wheel acceleration 38, and a revolution counter to measure wheel revolution time 40. It is to be understood that the pressure sensor, the temperature sensor, the sensor ID capacity, the tire ID capacity, the footprint length sensor, the accelerometer, and/or the revolution counter may be incorporated into the single sensor unit 26, or may be incorporated into multiple units. For the purpose of convenience, reference herein shall be made to a single sensor unit 26.

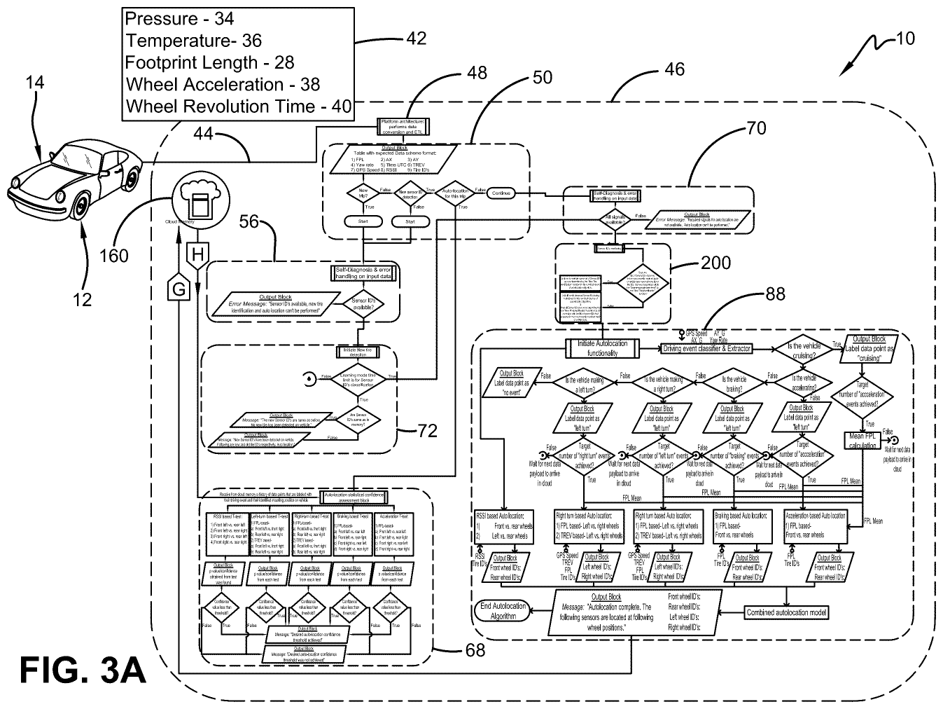

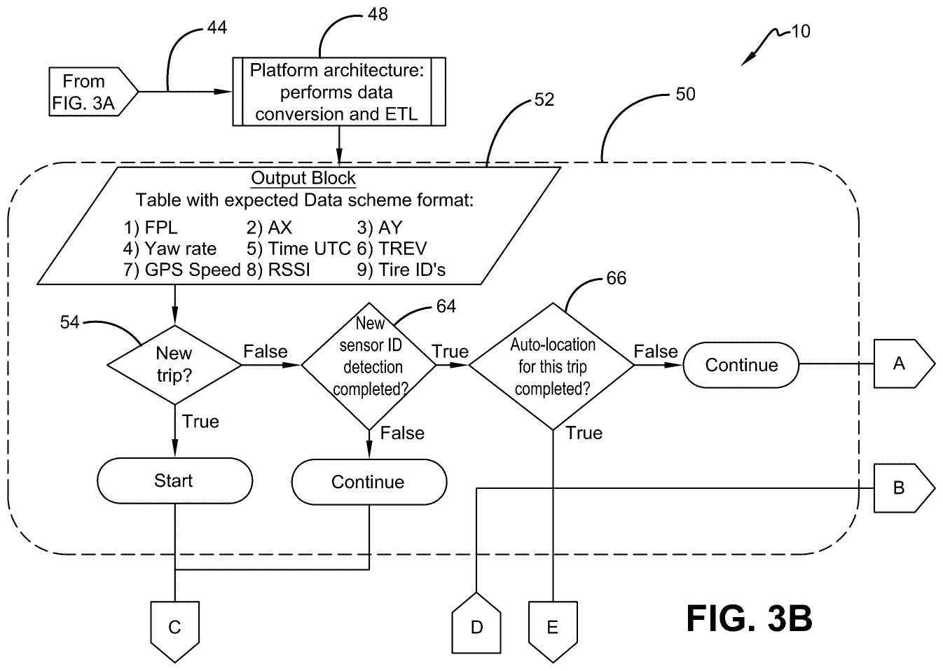

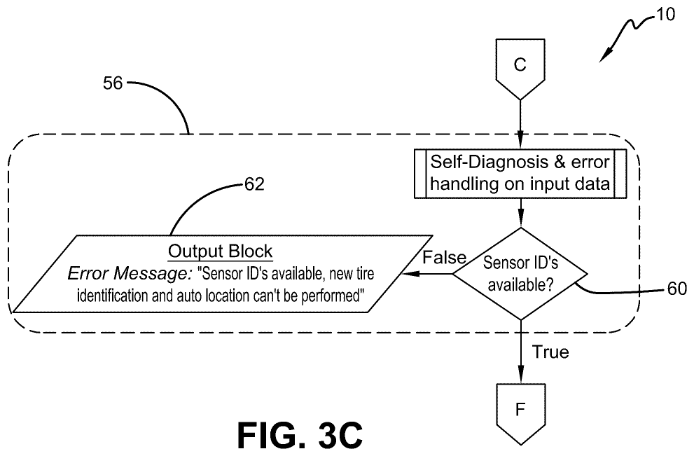

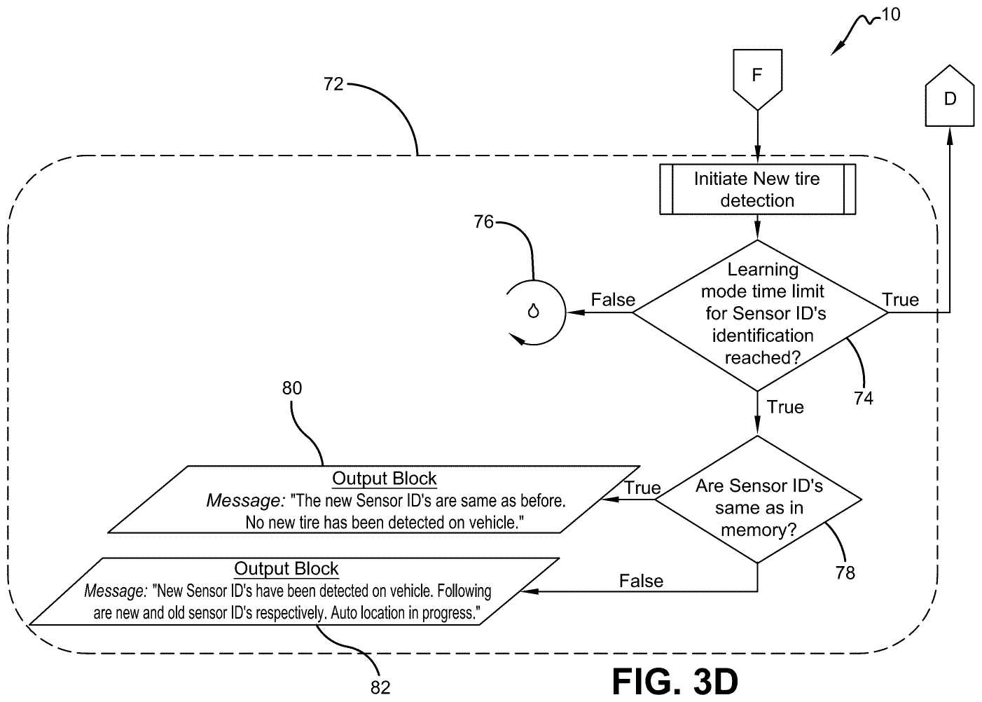

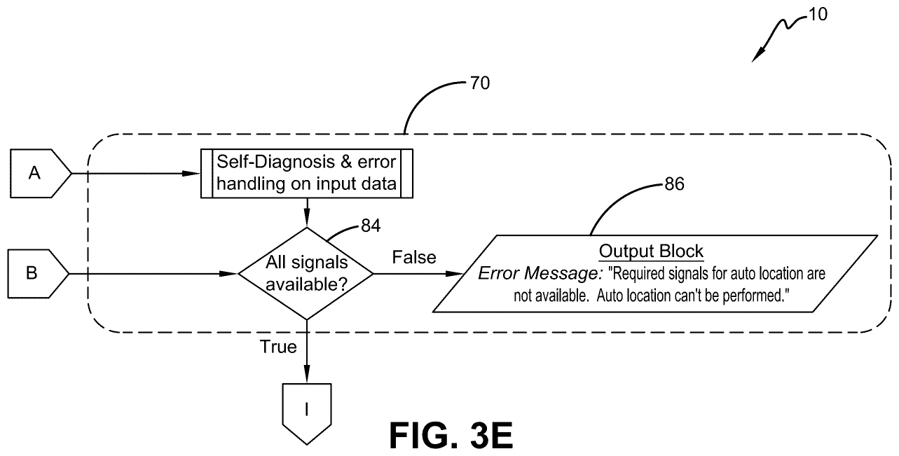

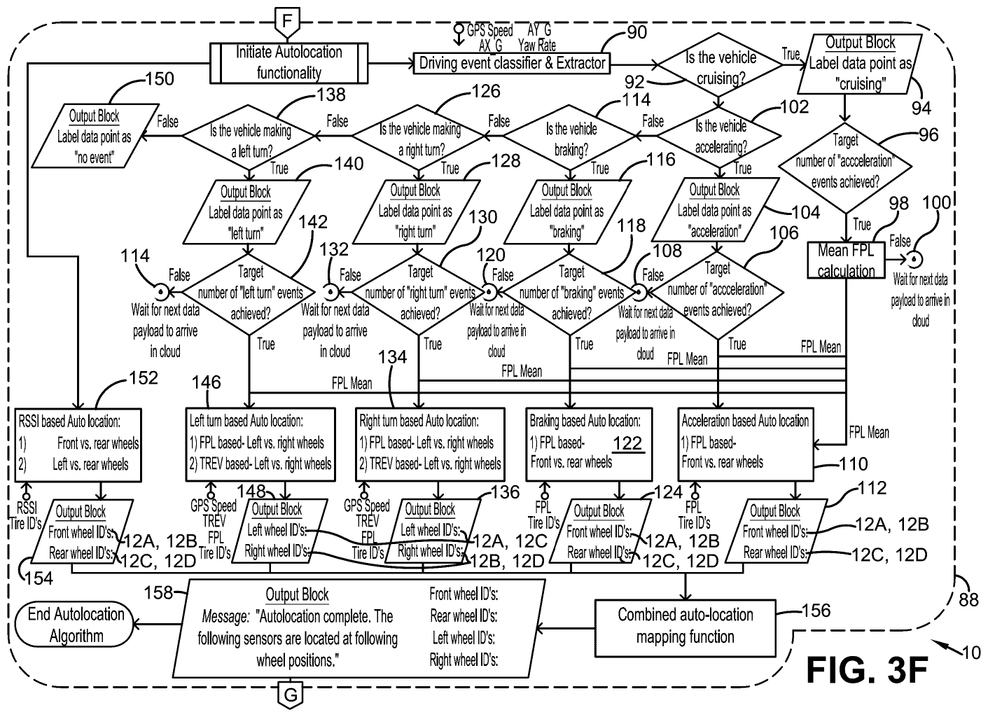

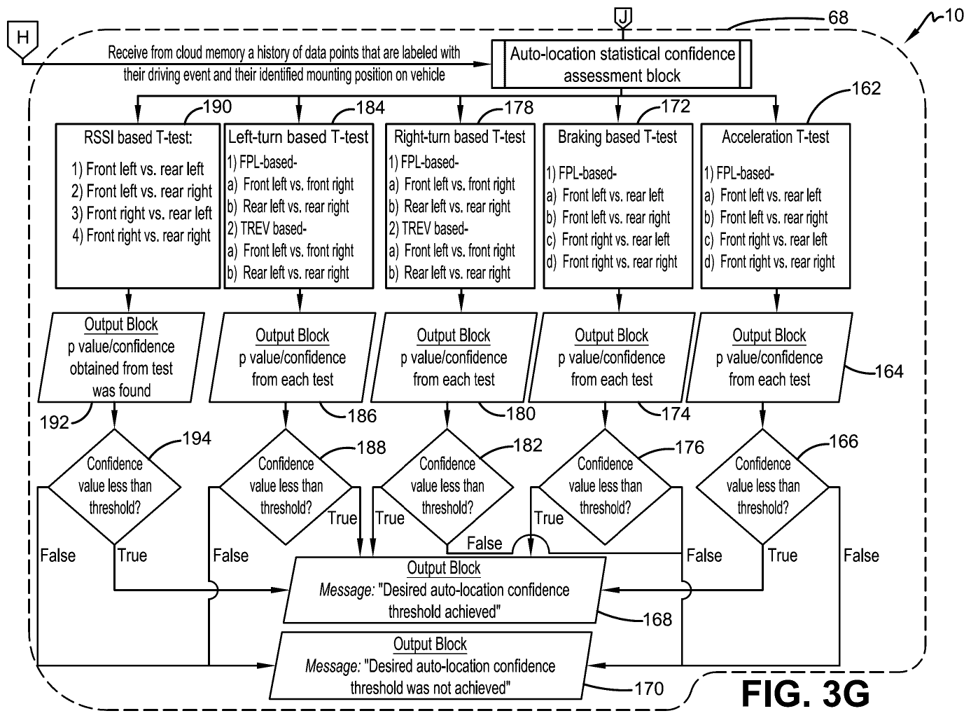

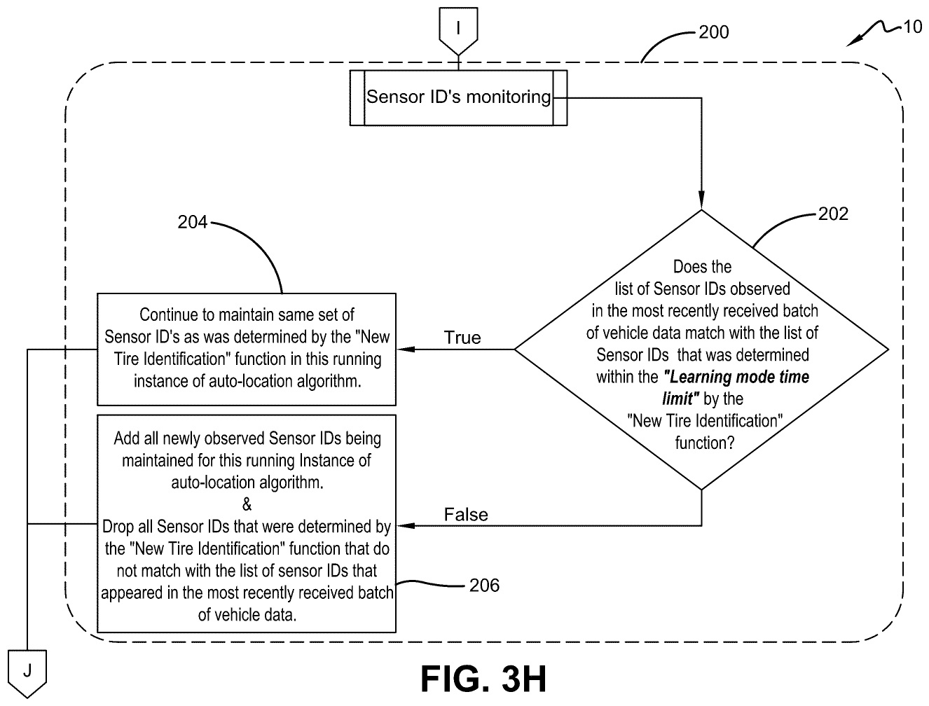

With reference to FIG. 3A, the parameters of tire pressure 34, tire temperature 36, footprint length 28, the wheel acceleration 38, and the wheel revolution time 40 are collectively referred to as sensed parameters 42. The sensor unit 26 includes wireless transmission means 44, such as an antenna, for wirelessly sending the sensed parameters 42 to a processor 46. The processor 46 may be integrated into the sensor unit 26, or may be a remote processor, which may be mounted on the vehicle 14 or be cloud-based. For the purpose of convenience, the processor 46 will be described as a cloud-based processor, with the understanding that the processor may alternatively be integrated into the sensor unit 26 or mounted on the vehicle 14.

Aspects of the auto-location system 10 preferably are executed on the processor 46, which enables input of the sensed parameters 42 and execution of specific analysis techniques, to be described below, which are stored in a suitable storage medium and are also in electronic communication with the processor. For preliminary treatment, the sensed parameters 26 are input into a data converter 48, which processes and normalizes the data from the sensed parameters for analysis.

Turning to FIG. 3B, after the data converter 48, output data 52 from the sensed parameters 26 are analyzed by an initial assessment module 50 to determine if the incoming data is for an ongoing trip, or if a new trip by the vehicle 14 is in progress 54. The output data 52 may include, by way of example, tire footprint length 28, lateral acceleration of the vehicle 14, longitudinal acceleration of the vehicle, yaw rate of the vehicle, a time stamp, a revolution time of the tire 12, a vehicle speed from a global positioning system (GPS), a received signal strength indication (RSSI) from each sensor unit 26, and/or sensor ID information.

If the data 52 from the sensed parameters 26 indicates that a new trip by the vehicle 14 is in progress, the system 10 proceeds to an initial system diagnosis module 56. If the data 52 from the sensed parameters 26 indicates that a new trip by the vehicle 14 is not in progress, an ongoing trip is in progress, and the data is reviewed to determine if new sensor ID detection has been completed 64. If the new sensor ID detection has not been completed, the system 10 again proceeds to the initial system diagnosis module 56. If the new sensor ID detection has been completed, the assessment module determines if auto-location for the current trip of the vehicle 14 has already been performed 66. If auto-location for the current vehicle trip has already been performed, the system 10 proceeds to an auto-location assessment module 68. If auto-location for the current vehicle trip has not been performed, the system proceeds to a location determination pre-assessment module 70.

Referring to FIG. 3C, in the initial system diagnosis module 56, a self-diagnosis of the system 10 is executed. As described in greater detail below, the system 10 is in communication with a cloud-based server 160, which saves data from the system. The initial system diagnosis module 56 checks for sensor ID information 60 in the saved data. If no sensor ID information is present in the saved data, the module generates a message that sensor ID information is not available 62. If sensor ID information is detected in the saved data, the system 10 proceeds to an identification review module 72.

As shown in FIG. 3D, the identification review module 72 detects a new tire 12. For the detection, the sensor ID information is reviewed for a predetermined period of time 74. Within the predetermined period of time, the review module 72 receives additional data 76 to continue to review the sensor ID information. When the predetermined period of time has elapsed, the system 10 proceeds to the location determination pre-assessment module 70. Also when the predetermined period of time has elapsed, the review module 72 determines if the sensor ID information matches previously received and stored sensor identification information 78 associated with the vehicle 14.

If the current sensor ID information matches sensor ID information identified for the vehicle 14 by the identification review module 72 when a previous iteration of the system 10 was running, the review module 72 generates a message that no new sensor ID information was found 80, as consistent sensor ID information corresponds to each tire 12 remaining in the same location on the vehicle from prior determinations. If the current sensor ID information does not match previously received and stored identification information, the review module 72 generates a message that auto location is being executed 82, as replacement or repositioning of one or more tires 12 may have occurred. It is to be understood that the system 10 may execute auto-location when the current sensor ID information matches sensor ID information identified for the vehicle 14 by the identification review module 72 when a previous iteration of the system 10 was running, as tire repositioning or rotation on the vehicle may have occurred.

Turning to FIG. 3E, the location determination pre-assessment module 70 verifies if all sensed parameter signals 42 are available 84. If the sensed parameter signals 42 are not available, the pre-assessment module 70 generates an error message that not all signals are available, so location cannot be performed 86. If the sensed parameter signals 42 are available, the system 10 proceeds to a sensor ID monitoring module 200.

As shown in FIG. 3H, the system 10 includes the sensor ID monitoring module 200. The sensor ID monitoring module 200 compares 202 the most recently received sensor ID information with the sensor ID information from the identification review module 72 (FIG. 3D). If the most recently received sensor ID information and the sensor ID information from the identification review module 72 match, the sensor ID information is maintained 204. If the most recently received sensor ID information and the sensor ID information from the identification review module 72 do not match, the most recently received sensor ID information is added to the stored data as described above, and the sensor ID information from the identification review module 72 that does not match the most recently received sensor ID information is removed or dropped 206. After the sensor ID information is compared in the sensor ID monitoring module, the system 10 proceeds to a location determination module 88.

Referring to FIG. 3F, the location determination module 88 executes a driving event classifier 90. The driving event classifier 90 determines from the sensed parameters 42 and the output data 52, such as the lateral acceleration of the vehicle 14, the longitudinal acceleration of the vehicle, and the yaw rate of the vehicle, whether the vehicle is traveling straight and at a steady speed, referred to as cruising 92. If the vehicle is traveling straight and at a steady speed, the data is labeled as cruising 94, which enables the determination of a mean footprint length 28. When the vehicle is cruising, the driving event classifier 90 checks whether a predetermined number of cruising events has been met 96. If so, a mean footprint length 28 for each tire 12 is determined 98. If the predetermined number of cruising events has not been met, the driving event classifier 90 waits for additional sensed parameters 42 to be received 100.

If the vehicle is not traveling straight and at a steady speed, the driving event classifier 90 determines, based on the sensed parameters 42, whether the vehicle 14 is accelerating 102. If the vehicle 14 is accelerating, the sensed parameters 42 are designated as acceleration data 104. The driving event classifier 90 then checks whether a predetermined number of acceleration events has been met 106. If the predetermined number of acceleration events has not been met, the driving event classifier 90 waits for additional sensed parameters 42 to be received 108. If the predetermined number of acceleration events has been met, the determined mean footprint length 98 is input into an acceleration-based auto-locator 110.

In the acceleration-based auto-locator 110, the front tire positions 12A and 12B are distinguished from the rear tire positions 12C and 12D. More particularly, when the vehicle 14 accelerates, there is typically a load transfer from the front tires 12A and 12B to the rear tires 12C and 12D. This load transfer results in a positive change or gain in the footprint length 28 for the rear tires 12C and 12D relative to the mean footprint length, and a negative change or reduction in the footprint length for the front tires 12A and 12B relative to the mean footprint length. This positive change in the footprint length 28 for the rear tires 12C and 12D and negative change in the footprint length for the front tires 12A and 12B enables the front tires to be distinguished from the rear tires. Once the front tires 12A and 12B are distinguished from the rear tires 12C and 12D, the relative front and rear positions are sent to an acceleration output block 112.

If the vehicle 14 is not accelerating, the driving event classifier 90 determines, based on the sensed parameters 42, whether the vehicle 14 is braking 114. If the vehicle 14 is braking, the sensed parameters 42 are designated as braking data 116. The driving event classifier 90 checks whether a predetermined number of braking events has been met 118. If the predetermined number of braking events has not been met, the driving event classifier 90 waits for additional sensed parameters 42 to be received 120. If the predetermined number of braking events has been met, the determined mean footprint length 98 is input into a braking-based auto-locator 122.

In the braking-based auto-locator 122, the front tire positions 12A and 12B are distinguished from the rear tire positions 12C and 12D. When the vehicle 14 brakes, there is typically a load transfer from the rear tires 12C and 12D to the front tires 12A and 12B. This load transfer results in a positive change or gain in the footprint length 28 for the front tires 12A and 12B relative to the mean footprint length, and a negative change or reduction in the footprint length for the rear tires 12C and 12D relative to the mean footprint length. This positive change in the footprint length 28 for the front tires 12A and 12B and negative change in the footprint length for the rear tires 12C and 12C enables the front tires to be distinguished from the rear tires. Once the front tires 12A and 12B are distinguished from the rear tires 12C and 12D, the relative front and rear positions are sent to a braking output block 124.

If the vehicle 14 is not braking, the driving event classifier 90 determines, based on the sensed parameters 42, whether the vehicle is executing a right turn 126. If the vehicle 14 is executing a right turn, the sensed parameters 42 are designated as right turn data 128. The driving event classifier 90 then checks whether a predetermined number of right turn events has been met 130. If the predetermined number of right turn events has not been met, the driving event classifier 90 waits for additional sensed parameters 42 to be received 132. If the predetermined number of right turn events has been met, the determined mean footprint length 98 is input into a right turn based auto-locator 134.

In the right turn based auto-locator 134, the left tire positions 12A and 12C are distinguished from the right tire positions 12B and 12D. More particularly, when the vehicle 14 executes a right turn, there is lateral load transfer from the inside or right side tires 12B and 12D to the outside or left side tires 12A and 12C. This load transfer results in a positive change or gain in the footprint length 28 for the left side tires 12A and 12C relative to the mean footprint length, and a negative change or reduction in the footprint length for right side tires 12B and 12D relative to the mean footprint length, which enables the left side tires to be distinguished from the right side tires.

In addition, during turning of the vehicle 14, each outer wheel turns 16 slower than the inner wheel. The speed difference between the wheel revolution time 40 (TREV) for each tire 12 and the speed of the vehicle 14 is expected to be positive for the tires on the outer wheels 16 and negative for the tires on the inner wheels, further enabling the left side tires 12A and 12C to be distinguished from the right side tires 12B and 12D. Once the left side tires 12A and 12C are distinguished from the right side tires 12B and 12D, the relative left and right positions are sent to a right turn output block 136.

If the vehicle 14 is not executing a right turn, the driving event classifier 90 determines, based on the sensed parameters 42, whether the vehicle is executing a left turn 138. If the vehicle 14 is executing a left turn, the sensed parameters 42 are designated as left turn data 140. The driving event classifier 90 then checks whether a predetermined number of left turn events has been met 142. If the predetermined number of left turn events has not been met, the driving event classifier 90 waits for additional sensed parameters 42 to be received 144. If the predetermined number of left turn events has been met, the determined mean footprint length 98 is input into a left turn based auto-locator 146.

In the left turn based auto-locator 146, the left tire positions 12A and 12C are distinguished from the right tire positions 12B and 12D. When the vehicle 14 executes a left turn, there is lateral load transfer from the inside or left side tires 12A and 12C to the outside or right side tires 12B and 12D. This load transfer results in a positive change or gain in the footprint length 28 for the right side tires 12B and 12D relative to the mean footprint length, and a negative change or reduction in the footprint length for left side tires 12A and 12C relative to the mean footprint length, which enables the left side tires to be distinguished from the right side tires.

In addition, during turning, the speed difference between the wheel revolution time 40 (TREV) for each tire 12 and the speed of the vehicle 14 is expected to be positive for the tires on the outer wheels 16 and negative for the tires on the inner wheels, further enabling the left side tires 12A and 12C to be distinguished from the right side tires 12B and 12D. Once the left side tires 12A and 12C are distinguished from the right side tires 12B and 12D, the relative left and right positions are sent to a left turn output block 148.

If the vehicle 14 is not executing a left turn, the driving event classifier 90 labels the sensed parameters 42 as a non-event 150, and the data are not used as inputs for auto-location based on footprint length 28 and TREV 40 methodology.

Optionally, the driving event classifier 90 may include a received signal strength indicator (RSSI) auto-locator 152. For example, when a vehicle-based processor or receiver is employed, it may be placed closer to the rear tires 12C and 12D than the front tires 12A and 12B. In such a case, the signal received from the sensor unit 26 in each of the rear tires 12C and 12D will be stronger than the strength of the signal received from the sensor unit in each of the front tires 12A and 12B, enabling the front tires to be distinguished from the rear tires. Once the front tires 12A and 12B are distinguished from the rear tires 12C and 12D, the relative front and rear positions are sent to an RSSI output block 154.

The front tire position data 12A and 12B and the rear tire position data 12C and 12D from the acceleration output block 112, the front tire position data and the rear tire position data from the braking output block 124, the left side tire position data and the right side tire position data from the right turn output block 136, the left side tire position data and the right side tire position data from the left turn output block 148, and optionally, the front tire position data and the rear tire position data from the RSSI output block 154, are sent to a combined auto-location mapping function 156. The combined auto-location mapping function 156 executes a comparison between the data from all of the output blocks, isolating the front tires 12A and 12B from the rear tires 12C and 12D, and the left tires from the right tires. In this manner, the position of each respective front left tire 12A, front right tire 12B, rear left tire 12C and rear right tire 12D is identified.

The identification of the position of respective front left tire 12A, front right tire 12B, rear left tire 12C and rear right tire 12D locations is output from the combined auto-location mapping function 156 to an auto-location output block 158. The output block 158 generates a message correlating each sensor unit 26, and thus its sensed parameters, to a respective front left tire 12A, front right tire 12B, rear left tire 12C and rear right tire 12D location.

Returning to FIG. 3A, the identified location or positions of each sensor unit 26 and its respective tire 12A, 12B, 12C and 12D is transmitted from the output block 158 to a cloud-based server 160. The cloud-based server 160 may be in electronic communication with control systems of the vehicle 14, a fleet management device, or a vehicle operator device. In this manner, the parameters sensed by each sensor unit 26 may be correlated to each respective tire 12A, 12B, 12C and 12D for use in vehicle control systems, a fleet manager, and/or an operator of the vehicle 14.

With reference to FIG. 3G, the auto-location assessment module 68 provides an analysis of historical data to ensure a satisfactory level of statistical confidence is achieved by the system 10. Location data as determined above, along with sensed parameter data 42, is input from the cloud-based server 160 into the assessment module 68. The assessment module 68 employs statistical tests to determine the level of statistical confidence reached by the system 10. An example of a statistical test that may be employed is an inferential statistical analysis, which is referred to as a T-test.

For example, an acceleration T-test 162 employs the change in footprint length 28 as described above from the acceleration data 104 to compare footprint-length based position determinations 112 for the front left tire 12A versus the rear left tire 12C, the front left tire versus the rear right tire 12D, the front right tire 12B versus the rear left tire, and the front right tire versus the rear right tire. The T-test 162 outputs a confidence value or level 164. The output confidence value 164 is compared to a predetermined threshold value 166. If the confidence value 164 is less than the threshold, the assessment module 68 generates a message that the auto-location confidence threshold of the system 10 has been achieved 168. If the confidence value 164 is not less than the threshold, the assessment module 68 generates a message that the auto-location confidence threshold of the system 10 has not been achieved 170.

A braking-based T-test 172 employs the change in footprint length 28 as described above from the braking data 116 to compare footprint-length based position determinations 124 for the front left tire 12A versus the rear left tire 12C, the front left tire versus the rear right tire 12D, the front right tire 12B versus the rear left tire, and the front right tire versus the rear right tire. The T-test 172 outputs a confidence value or level 174. The output confidence value 174 is compared to a predetermined threshold value 176. If the confidence value 174 is less than the threshold, the assessment module 68 generates the message that the auto-location confidence threshold of the system 10 has been achieved 168. If the confidence value 174 is not less than the threshold, the assessment module 68 generates the message that the auto-location confidence threshold of the system 10 has not been achieved 170.

A right-turn based T-test 178 employs labeled data points from the right turn data 128 to compare right turn determinations 136, including the change in footprint length 28 and the speed difference based determinations described above for the front left tire 12A versus the front right tire 12B and the rear left tire 12C versus the rear right tire 12D. The T-test 178 outputs a confidence value or level 180. The output confidence value 180 is compared to a predetermined threshold value 182. If the confidence value 180 is less than the threshold, the assessment module 68 generates the message that the auto-location confidence threshold of the system 10 has been achieved 168. If the confidence value 180 is not less than the threshold, the assessment module 68 generates the message that the auto-location confidence threshold of the system 10 has not been achieved 170.

A left-turn based T-test 184 employs labeled data points from the left turn data 140 to compare left turn determinations 148, including the change in footprint length 28 and the speed difference based determinations described above for the front left tire 12A versus the front right tire 12B and the rear left tire 12C versus the rear right tire 12D. The T-test 184 outputs a confidence value or level 186. The output confidence value 188 is compared to a predetermined threshold value 190. If the confidence value 188 is less than the threshold, the assessment module 68 generates the message that the auto-location confidence threshold of the system 10 has been achieved 168. If the confidence value 188 is not less than the threshold, the assessment module 68 generates the message that the auto-location confidence threshold of the system 10 has not been achieved 170.

An RSSI-based T-test 190 employs the RSSI determinations 154 to compare position determinations for the front left tire 12A versus the rear left tire 12C, the front left tire versus the rear right tire 12D, the front right tire 12B versus the rear left tire, and the front right tire versus the rear right tire. The T-test 190 outputs a confidence value or level 192. The output confidence value 192 is compared to a predetermined threshold value 194. If the confidence value 192 is less than the threshold, the assessment module 68 generates the message that the auto-location confidence threshold of the system 10 has been achieved 168. If the confidence value 192 is not less than the threshold, the assessment module 68 generates the message that the auto-location confidence threshold of the system 10 has not been achieved 170.

In this manner, the auto-location system 10 of the present invention employs sensed parameters 42, including the tire footprint length 28, to identify and locate the position of each tire 12 on a vehicle 14. As described above, the auto-location system 10 generates notifications when a newly mounted tire 12 on the vehicle 14 is detected, accompanied by the tire location or mounting position. The system 10 also generates notifications when a mounting position or location of a tire 12 has been changed, such as in a tire rotation procedure, accompanied by the new tire position or location. The system 10 provides economical and accurate identification of the location of each tire 12 on the vehicle 14 with self-diagnosis, and optionally includes an assessment module 68 that analyzes historical data to ensure a satisfactory level of statistical confidence is achieved by the system.

As described above, the output block 158 generates a message correlating each sensor unit 26, and thus its sensed parameters, to a respective front left tire 12A, front right tire 12B, rear left tire 12C and rear right tire 12D location. The identified location or position of each sensor unit 26 and its respective tire 12A, 12B, 12C and 12D may be transmitted from the output block 158 to a cloud-based server 160. The cloud-based server 160 may be in electronic communication with control systems of the vehicle 14. In this manner, the system 10 may generate a correlation of each sensor unit 26, and the parameters sensed by each sensor unit, to the position of each respective tire 12A, 12B, 12C and 12D for actuation of a vehicle control system in response to the correlation. The correlation may thus be employed to actuate and improve the function of a vehicle control system. Such vehicle control systems may include antilock braking systems (ABS), traction control systems, suspension control systems, steering control systems, electronic stability control systems (ECS), and the like.

Also as described above, the sensor unit 26 is mounted on the tire 12 to measure the sensed tire parameters 42, including tire pressure 34, tire temperature 36, footprint length 28, wheel acceleration 38, and/or wheel revolution time 40. Such tire-based sensor units 26 are different from vehicle-based sensors, as known to those skilled in the art, as vehicle-based sensors are mounted on a frame, chassis, or other component of the vehicle 14, rather than on the tire 12. In addition to being different in structure and/or operation from tire-based sensor units 12, such vehicle-based sensors may measure parameters that are different from the tire-based sensed parameters 42.

The present invention also includes a method for locating the position of a tire 12 on a vehicle 14. The method includes steps in accordance with the description that is presented above and shown in FIGS. 1 through 3H.

It is to be understood that the structure and method of the above-described auto-location system may be altered or rearranged, or components or steps known to those skilled in the art omitted or added, without affecting the overall concept or operation of the invention. For example, electronic communication may be through a wired connection or wireless communication without affecting the overall concept or operation of the invention. Such wireless communications include radio frequency (RF) and Bluetooth® communications.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. An auto-location system, the location system locating a position of a tire supporting a vehicle, the system comprising:
a sensor unit being mounted on the tire, the sensor unit including a footprint length measurement sensor to generate footprint length measurements of the tire;
the sensor unit generating additional sensed parameters from at least one of a pressure sensor to measure a pressure of the tire, a temperature sensor to measure a temperature of the tire, an accelerometer for measuring acceleration of a wheel on which the tire is mounted, and a revolution counter to measure a revolution time of the wheel;
a processor in electronic communication with the sensor unit, wherein the processor:
obtains, from the sensor unit mounted on the tire, footprint length measurements;
obtains, from the sensor unit mounted on the tire, the additional sensed parameters;
a driving event classifier executable on the processor, wherein, when executed, the driving event classifier causes the processor to at least:
receive the footprint length measurements;
receive the additional sensed parameters;
obtain output data from the sensed parameters, including a lateral acceleration of the vehicle and a longitudinal acceleration of the vehicle;
apply the footprint length measurements, the additional sensed parameters, and the output data to determine when the vehicle is cruising;
determine a mean footprint length of the tire from the footprint length measurements when the vehicle is cruising; and
when the vehicle is determined as not cruising, apply the footprint length measurements to determine when the vehicle is accelerating, braking, and executing a turn;
an acceleration-based auto-locator executable on the processor, wherein, when executed, the acceleration-based auto-locator causes the processor to at least:
receive the mean footprint length and the footprint length measurements when the vehicle is accelerating; and
determine the position of the tire on the vehicle by comparing the measured footprint lengths to the mean footprint length when the vehicle is accelerating;
a braking-based auto-locator executable on the processor, wherein, when executed, the braking-based auto-locator causes the processor to at least:
receive the mean footprint length and the footprint length measurements when the vehicle is braking; and
determine the position of the tire on the vehicle by comparing the measured footprint lengths to the mean footprint length when the vehicle is braking;
a turn-based auto-locator executable on the processor, wherein, when executed, the turn-based auto-locator causes the processor to at least:
receive the mean footprint length and the footprint length measurements when the vehicle is executing a turn; and
determine the position of the tire on the vehicle by comparing the measured footprint lengths to the mean footprint length when the vehicle is executing a turn;
an auto-location output block executable on the processor, wherein, when executed, the auto-location output block causes the processor to at least:
receive the determined position of the tire on the vehicle; and
generate a correlation of the sensor unit to the position of the tire on the vehicle for actuation of a vehicle control system in response to the correlation; and
an auto-location assessment module executable on the processor to determine a level of statistical confidence reached by the system, wherein, when executed, the auto-location assessment module causes the processor to execute an acceleration statistical test to compare footprint-length based position determinations, a braking-based statistical test to compare footprint-length based position determinations, a right-turn based statistical test to compare right turn determinations, and a left-turn based statistical test to compare left turn determinations.

2. The auto-location system of claim 1, wherein the sensor unit further comprises electronic memory capacity for storing identification information for the tire.

3. The auto-location system of claim 1, wherein the driving event classifier determines the vehicle is cruising when a predetermined number of cruising events has been met.

4. The auto-location system of claim 1, wherein the driving event classifier determines whether the vehicle is accelerating when a predetermined number of acceleration events has been met.

5. The auto-location system of claim 1, wherein a front tire position is distinguished from a rear tire position in the acceleration-based locator using a change of the measured footprint lengths from the determined mean footprint length when the vehicle is accelerating.

6. The auto-location system of claim 1, wherein the driving event classifier determines whether the vehicle is braking when a predetermined number of braking events has been met.

7. The auto-location system of claim 1, wherein a front tire position is distinguished from a rear tire position in the braking-based auto-locator using a change of the measured footprint lengths from the determined mean footprint length when the vehicle is braking.

8. The auto-location system of claim 1, wherein the driving event classifier determines whether the vehicle is executing a turn when a predetermined number of turn events has been met.

9. The auto-location system of claim 1, wherein a left tire position is distinguished from a right tire position in the turn based auto-locator using a change of the measured footprint lengths from the determined mean footprint length when the vehicle is executing a turn.

10. The auto-location system of claim 8, wherein a left tire position is distinguished from a right tire position in the turn based auto-locator using a speed difference between a wheel revolution time and a speed of the vehicle when the vehicle is executing a turn.

11. The auto-location system of claim 8, wherein the turn includes a right turn.

12. The auto-location system of claim 8, wherein the turn includes a left turn.

13. The auto-location system of claim 3, wherein the driving event classifier includes a received signal strength indicator locator to distinguish a front tire position from a rear tire position.

14. The auto-location system of claim 1, further comprising an initial assessment module executed on the processor to determine if location of the tire for a current trip of the vehicle has already been performed.

15. The auto-location system of claim 1, further comprising an initial system diagnosis module executed on the processor, the initial system diagnosis module executing a self-diagnosis of the system by checking for sensor identification information in saved system data.

16. The auto-location system of claim 1, further comprising an identification review module executed on the processor, the module including an initiation of a detection of a new tire by:
reviewing received sensor identification information for a predetermined period of time;
determining if the received sensor identification information matches previously received sensor identification information;
if the received sensor identification information matches the previously received sensor identification information, the review module generates a message that no new sensor identification information was found; and
if the received sensor identification information does or does not match the previously received identification information, the system executes auto-location.

17. The auto-location system of claim 1, further comprising a location determination pre-assessment module executed on the processor, which verifies if all parameters sensed by the sensor unit are available.

18. The auto-location system of claim 1, wherein:
the acceleration statistical test includes a T-test employing acceleration data;
the braking-based statistical test includes a T-test employing braking data;
the right-turn based statistical test includes a T-test employing right turn data; and
wherein the left-turn based statistical test includes a T-test employing left turn data.

19. The auto-location system of claim 18, wherein the auto-location assessment module further comprises a received signal strength indicator based T-test employing received signal strength indicators to compare position determinations.

20. The auto-location system of claim 19, wherein at least one of the T-tests outputs a confidence value, wherein if the confidence value is less than a threshold, the auto-location assessment module generates a message that an auto-location confidence threshold of the system has been achieved, and if the confidence value is not less than the threshold, the auto-location assessment module generates a message that the auto-location confidence threshold of the system has not been achieved.
